(19) United States
(12) Patent Application Publication
(10) Pub. No.: US 2008/0309583 A1
(43) Pub. Date: Dec. 18, 2008

(54) RECEIVING ASSEMBLY WITH FUNCTION OF DISPLAYING SCANNING IMAGES ABOUT OBJECTS THEREIN

(76) Inventor: CHIH-CHING HSIEH, Taichung City (TW)

Correspondence Address: CHIH-CHING HSIEH, 235 Chung-Ho Box 8-24, Taipei, 235, TW

(21) Appl. No.: 11/762,069

(22) Filed: Jun. 13, 2007

(51) Int. Cl. G09G 5/00

(52) U.S. Cl. 345/3.2

(57) ABSTRACT

A receiving assembly with a function of displaying scanning images about objects therein comprises a container having at least one receiving unit; at least one scanning unit being installed in the receiving unit for scanning data about objects in the receiving unit and transferring the data; a display unit for receiving data from the at least one scanning unit and displaying the data on a screen of the display unit; the display unit being installed at an exterior of the container; and an operating unit for adjusting display ways of the display unit, and wherein by the display unit to display data from the scanning unit, the object in the receiving unit can be known. The operating unit serves to divide the screen of the display unit into one frame or a plurality of sub-frames and the scanning unit includes a track unit, a driving unit and a scanning assembly.

### FIELD OF THE INVENTION

The present invention relates to toolboxes, and particularly to a receiving assembly with a function of displaying scanning images about objects therein so that the user can know the information about the tool in the toolbox without needing to open the toolbox.

### BACKGROUND OF THE INVENTION

Currently more and more tools are used in working or daily life. Thus tool boxes are developed for locating the tools. However because there are many tools being used and thus they are located in the box. As too many different kinds of tools are placed in the tool box, they are often not classified or identified. Furthermore, the tools are not located with an order known by the users or according to the indications on the box. As a result, the user can not know the objects in the toolbox, or can not know what tools are placed in the toolbox, even can not know that a tool is placed in which drawer for searching. There are some developments related to toolboxes being disclosed. However all these developments are aimed at the improvement of the mechanical structure of the toolbox, for example installing sliding tracks and elastic units to guide the drawers so that the user can open or close the drawers easily and conveniently, but these improved structures can not resolve above problems about the searching of a tool.

Thus there is an eager demand for a novel design which can improve the prior art defects.

### SUMMARY OF THE INVENTION

Accordingly, the primary object of the present invention is to provide a receiving assembly with a function of displaying scanning images about objects therein so that the user can know the information about the tool in the toolbox without needing to open the toolbox.

To achieve above objects, the present invention provides a receiving assembly with a function of displaying scanning images about objects therein, comprising: a container having at least one receiving unit; at least one scanning unit being installed in the receiving unit for scanning data about objects in the receiving unit and transferring the data; a display unit for receiving data from the at least one scanning unit and display the data on a screen of the display unit; the display unit being installed at an exterior of the container; and an operating unit for adjusting display ways of the display unit; and wherein by the display unit to display data from the scanning unit, the object in the receiving unit can be known. Furthermore, the operating unit serves to divide the screen of the display unit into one frame or a plurality of sub-frames and the scanning unit includes a track unit, a driving unit and a scanning assembly; the track unit serves to install the scanning assembly and the driving unit provides power to drive the scanning assembly so as to drive the scanning assembly to move along the track unit to a predetermined position for scanning features of the object in the container.

The various objects and advantages of the present invention will be more readily understood from the following detailed description when read in conjunction with the appended drawing.

### BRIEF DESCRIPTION OF THE DRAWINGS

FIG. 1 is a schematic perspective view of the structure of the present invention.

FIG. 2 is a schematic view about the first embodiment of the present invention.

FIGS. 3 and 4 are assembled schematic views showing the different displaying sections according to the present invention.

FIG. 5 shows the second embodiment of the present invention.

FIG. 6 shows the third embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

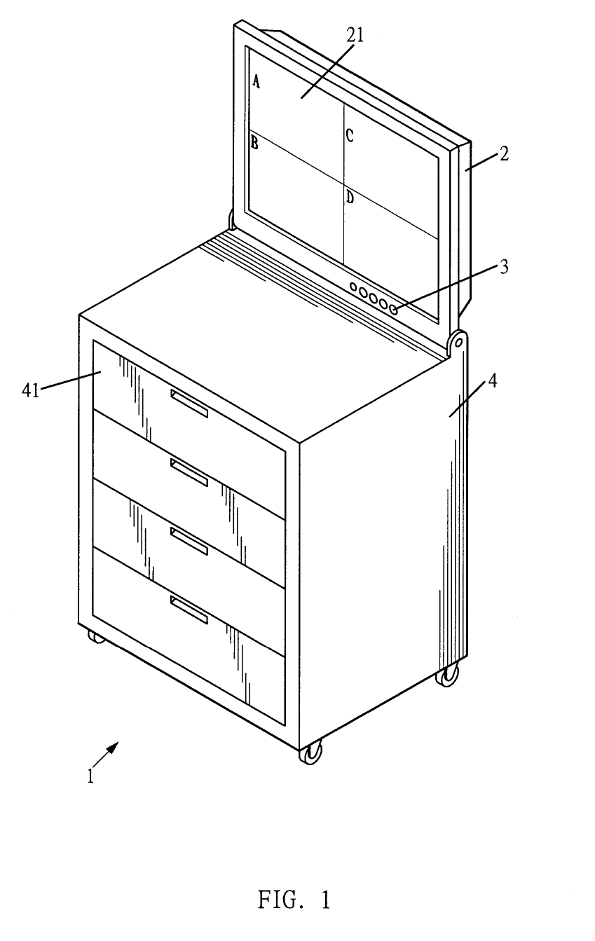

Referring to FIG. 1, the receiving assembly 1 with a function of displaying contents therein. The present invention has the following elements.

A container 4 has a plurality of receiving units 41 for receiving and storing objects. The receiving units 41 can be opened or closed freely. In this embodiment, the receiving unit 41 are drawers.

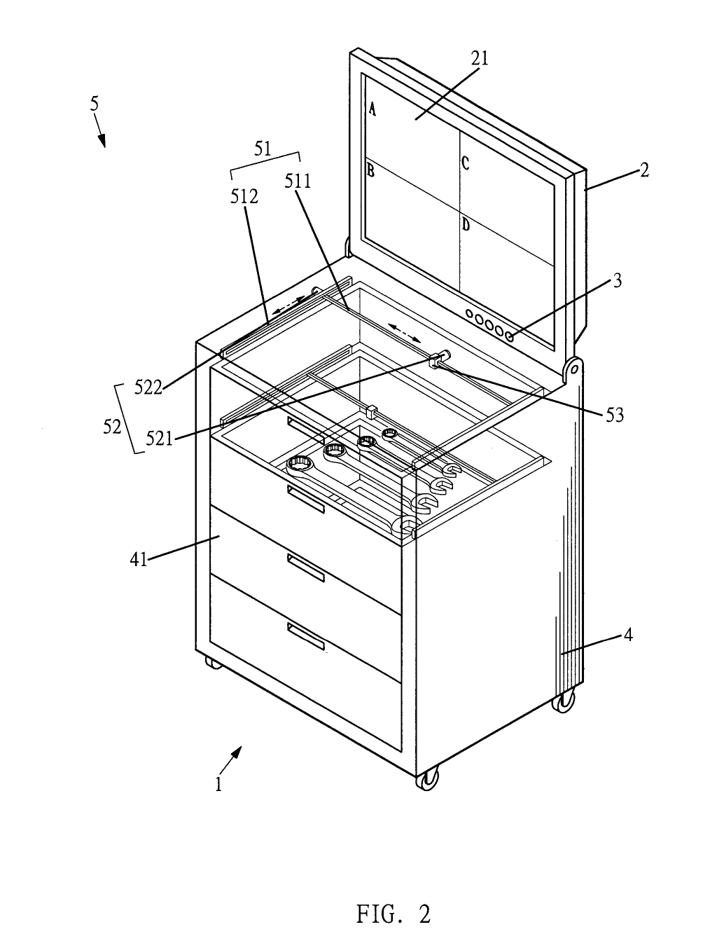

At least one scanning unit 5 is included. In this embodiment, each receiving unit 41 has a scanning unit 5 (referring to FIG. 2) for scanning image about the objects in the receiving unit 41. However in the present invention, maybe some receiving units 41 have no scanning unit 5 or one receiving unit 41 has more than one scanning unit 5. All these are within the scope of the present invention. The scanning unit 5 includes a track unit 51, a driving unit 52 and a scanning assembly 53. The track unit 51 serves to install the scanning assembly 53 and the driving unit 52 provides power to the scanning assembly 53 so as to drive the scanning assembly 53 to move along the track unit 51 to a predetermined position for scanning features of the object in the container. The data captured from the scanning assembly 53 is transferred out.

A display unit 2 is for example a liquid crystal display, an LED display, a cathode ray display, a plasma display, etc. The display unit 2 receives scanning data from the scanning unit 5 and then displays the data about the pressure, volume, area, weight, etc., of the object.

An operating unit 3 is installed near the display unit 2. The operating unit 3 serves to control and adjust the display unit 2. The user changes the displaying way by controlling and adjusting the display unit 2. The frame of the display unit 2 can be divided into a plurality of sub-frames 21 or a single frame 21.

Thus, in use, the receiving assembly 1 of the present invention can display the contents in the container 4. The user can operate the operating unit 3 so as to divide the frame of the display unit 2 into one frame 21 or a plurality of sub-frames 21.

Referring to FIG. 2, in this embodiment, it is illustrated that the track unit 51 includes an X axis track unit 511 and a Y axis track unit 512. The Y axis track unit 512 is retained to walls of the receiving unit and the X axis track unit 511 is retained to the Y axis track unit 512. The display unit includes an X axis driving unit 521 and a Y axis driving unit 522. In this embodiment, the scanning assembly 53 is installed to the X axis track unit 511. The X axis driving unit 521 serves to drive scanning assembly 53 to move along the X axis track unit 511 and the Y axis track unit 512 serves to drive the X axis track unit 511 to move along the Y axis track unit 512.

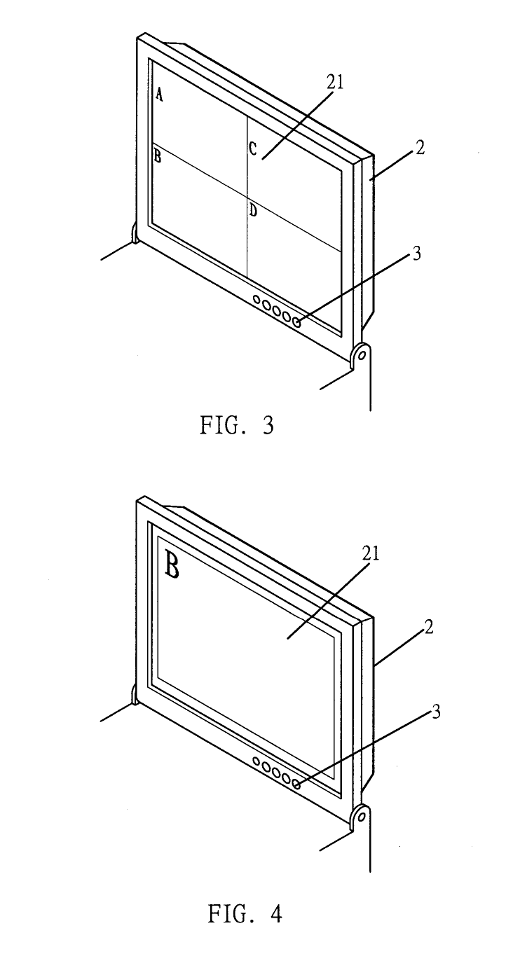

Referring to FIGS. 3 and 4, in FIG. 3, it is illustrated that the frame of the display unit 2 is divided into four sub-frames 21 by adjusting the operating unit 3 or the frame of the spacing 21 has only one frame 21 (see FIG. 4). All these are determined by the requirement of the user.

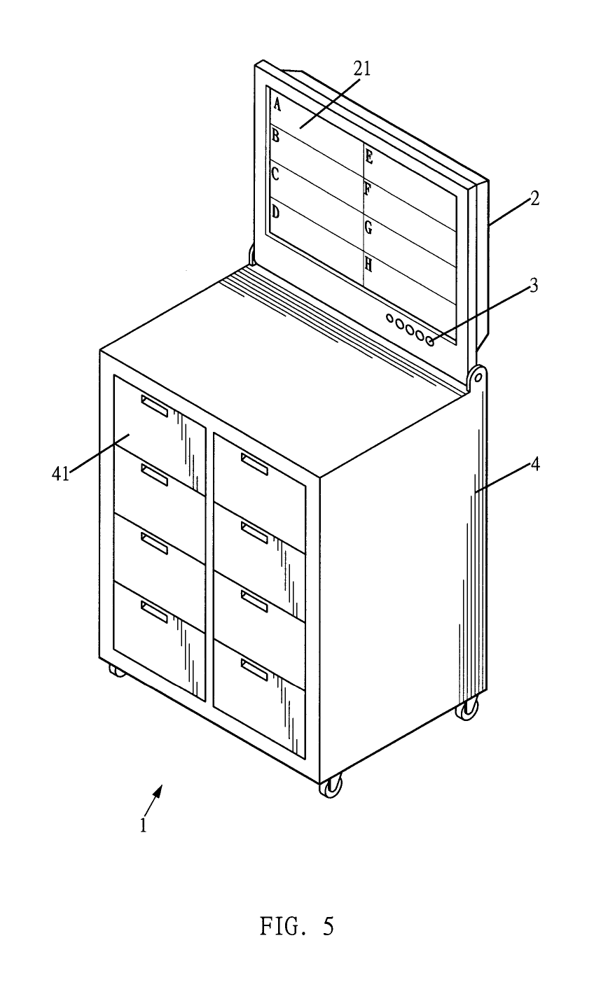

Referring to FIGS. 5, the second embodiment of the present invention is illustrated. In this embodiment, those identical to the above embodiment will not be further described herein. Only those different from above embodiment are described. In this embodiment, the container 4 has eight receiving units 41 and the frame of the display unit 2 is divided into eight sub-frames 21.

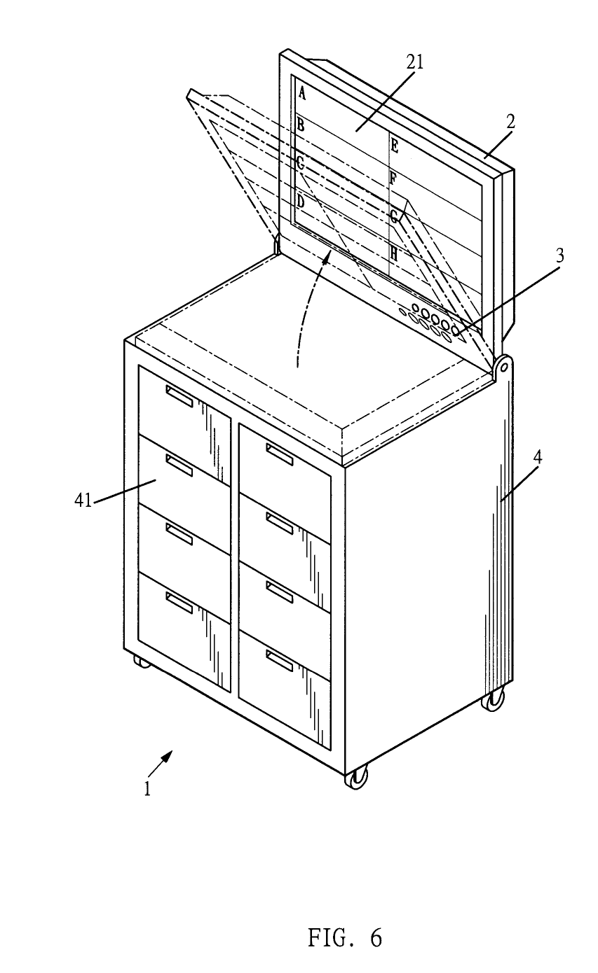

Referring to FIGS. 6, the third embodiment of embodiment is illustrated. In this embodiment, those identical to the above embodiment will not be further described herein. Only those different from above embodiment are described. It is illustrated in FIG. 6 that the display unit 2 is folded for storage and damage-proof. In FIG. 6, it is illustrated that the display unit 2 is folded to be adhered upon an upper surface of the container 4.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A receiving assembly with a function of displaying scanning images about objects therein, comprising:
a container having at least one receiving unit;
at least one scanning unit being installed in the receiving unit for scanning data about objects in the receiving unit and transferring the data;
a display unit for receiving data from the at least one scanning unit and displaying the data on a screen of the display unit; the display unit being installed at an exterior of the container; and
an operating unit for adjusting display ways of the display unit; and
wherein by the display unit to display data from the scanning unit, the object in the receiving unit can be known.

2. The receiving assembly with a function of displaying scanning images about objects therein as claimed in claim 1, wherein the operating unit serves to divide the screen of the display unit into one frame or a plurality of sub-frames.

3. The receiving assembly with a function of displaying scanning images about objects therein as claimed in claim 1, wherein the scanning unit includes a track unit, a driving unit and a scanning assembly; the track unit serves to install the scanning assembly and the driving unit provides power to drive the scanning assembly so as to drive the scanning assembly to move along the track unit to a predetermined position for scanning features of the object in the container.

4. The receiving assembly with a function of displaying scanning images about objects therein as claimed in claim 1, wherein the track unit includes an X axis track unit and a Y axis track unit; and the scanning assembly moves along the X axis track unit and the Y axis track unit.

5. The receiving assembly with a function of displaying scanning images about objects therein as claimed in claim 1, wherein the driving unit includes an X axis driving unit and a Y axis driving unit for driving the scanning assembly to move along the track unit.

6. The receiving assembly with a function of displaying scanning images about objects therein as claimed in claim 1, wherein the track unit includes a X axis track unit and a Y axis track unit and the driving unit includes an X axis driving unit and a Y axis driving unit for driving the scanning assembly to move on the track unit.

7. The receiving assembly with a function of displaying scanning images about objects therein as claimed in claim 1, wherein the driving unit includes an X axis driving unit and a Y axis driving unit; and the X axis driving unit and the Y axis driving unit are servo motors.

8. The receiving assembly with a function of displaying scanning images about objects therein as claimed in claim 1, wherein the scanning assembly is installed to an X axis track unit and the X axis track unit is installed to the Y axis track unit.

9. The receiving assembly with a function of displaying scanning images about objects therein as claimed in claim 1, wherein the receiving unit is a drawer.

10. The receiving assembly with a function of displaying scanning images about objects therein as claimed in claim 1, wherein the display unit is foldable to be placed upon a surface of the container.
